(19) United States
(12) Patent Application Publication
(10) Pub. No.: US 2026/0136100 A1
(43) Pub. Date: May 14, 2026

(54) IMAGING APPARATUS, OPERATION METHOD OF IMAGING APPARATUS, AND OPERATION PROGRAM OF IMAGING APPARATUS

(71) Applicant: FUJIFILM Corporation, Tokyo (JP)

(72) Inventors: Taku Yamashita, Saitama (JP); Yi Pan, Saitama (JP); Junya Kitagawa, Saitama (JP)

(73) Assignee: FUJIFILM Corporation, Tokyo (JP)

(21) Appl. No.: 19/334,967

(22) Filed: Sep. 22, 2025

(30) Foreign Application Priority Data
Sep. 30, 2024 (JP) 2024-171527

(51) Int. Cl. H04N 23/68

(52) U.S. Cl. CPC H04N 23/6815; H04N 23/683; H04N 23/687

(57) ABSTRACT

An imaging apparatus includes a processor, in which the processor is configured to acquire displacement information including an orientation and a magnitude of displacement, and positional information of a target to be moved that is moved for shake correction, and in a case where the displacement information satisfies a predetermined condition, and a position of the target to be moved is not at a predetermined position, determine a correction amount of the target to be moved using a second correction function of which a restoration time of the target to be moved to the predetermined position is shorter than a restoration time of a first correction function, instead of the first correction function.

### CROSS-REFERENCE TO RELATED APPLICATIONS

The present application claims priority under 35 U.S.C. § 119 to Japanese Patent Application No. 2024-171527 filed on Sep. 30, 2024. The above application is hereby expressly incorporated by reference, in its entirety, into the present application.

### BACKGROUND

### 1. Technical Field

The disclosed technology relates to an imaging apparatus, an operation method of an imaging apparatus, and an operation program of an imaging apparatus.

### 2. Description of the Related Art

JP2024-035336A discloses a control device that controls shake correction performed by driving first image shake correction means for moving an optical element included in an imaging optical system and second image shake correction means for moving an imaging element. The control device comprises determination means for determining strength of the shake correction, calculation means for calculating a target correction amount of at least one of the first image shake correction means or the second image shake correction means based on the strength of the shake correction determined by the determination means and on a shake amount of an imaging apparatus, and a controller that controls the first image shake correction means and the second image shake correction means using a plurality of methods including at least a first control method and a second control method. In controlling using the first control method, the determination means determines the strength of the shake correction based on positional information of the optical element. In controlling using the second control method, the determination means determines the strength of the shake correction based on positional information of the imaging element.

JP2021-085925A discloses an imaging apparatus including a first detection unit that detects a shake of the imaging apparatus, a second detection unit that detects a motion of an image between different frames before capturing a predetermined still image, a subject angular velocity detection unit that detects a subject angular velocity before a still image exposure period from detection results of the first detection unit and the second detection unit, a subject angular velocity prediction unit that determines an inflection point of a subject angular acceleration before the still image exposure period based on the subject angular velocity before the still image exposure period and predicts the subject angular velocity in the still image exposure period based on the inflection point and the subject angular velocity before the still image exposure period, and a shake correction unit that corrects a shake of a subject based on the subject angular velocity predicted by the subject angular velocity prediction unit.

### SUMMARY

One embodiment according to the disclosed technology provides an imaging apparatus, an operation method of an imaging apparatus, and an operation program of an imaging apparatus capable of reducing a restoration time of a target to be moved to a predetermined position under a predetermined condition.

In order to achieve the above object, according to an aspect of the disclosed technology, there is provided an imaging apparatus comprising a processor, in which the processor is configured to acquire displacement information including an orientation and a magnitude of displacement, and positional information of a target to be moved that is moved for shake correction, and in a case where the displacement information satisfies a predetermined condition, and a position of the target to be moved is not at a predetermined position, determine a correction amount of the target to be moved using a second correction function of which a restoration time of the target to be moved to the predetermined position is shorter than a restoration time of a first correction function, instead of the first correction function.

The predetermined condition may include a condition that a panning operation or a tilting operation is finished and a time set in advance elapses.

The processor may be configured to, during the panning operation or the tilting operation, determine the correction amount using the first correction function.

The processor may be configured to, in a case where the target to be moved is restored to the predetermined position, restore the second correction function to the first correction function.

The predetermined condition may include a condition that a panning operation or a tilting operation is being performed.

The predetermined condition may include a condition that the displacement caused by an operation intended by a user is finished, or the displacement caused during the operation intended by the user continues for a certain amount of time.

The predetermined condition may include a condition that the imaging apparatus is determined to be at a standstill.

The processor may be configured to, in a case where use of the second correction function continues even after the target to be moved is restored to the predetermined position, and the displacement exceeds a predetermined threshold value, restore the second correction function to the first correction function.

Both of the first correction function and the second correction function may be functions in which correction strength is decreased as the position of the target to be moved is separated from the predetermined position.

The first correction function may be a function in which correction strength is decreased as the position of the target to be moved is separated from the predetermined position, and the second correction function may be a function in which an amount of change in the correction strength corresponding to the position of the target to be moved is smaller than an amount of change in the correction strength of the first correction function.

The target to be moved may be an imaging sensor in a case where a method of the shake correction is a sensor shift method, a lens in a case where the method of the shake correction is a lens shift method, or an image cutout position in a case where the method of the shake correction is an electronic correction method.

According to another aspect of the disclosed technology, there is provided an operation method of an imaging apparatus including a processor, the method comprising, via the processor, acquiring displacement information including an orientation and a magnitude of displacement, and positional information of a target to be moved that is moved for camera shake correction, and determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.

According to still another aspect of the disclosed technology, there is provided an operation program of an imaging apparatus including a processor, the program causing the processor to execute a process comprising acquiring displacement information including an orientation and a magnitude of displacement, and positional information of a target to be moved that is moved for camera shake correction, and determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.

### BRIEF DESCRIPTION OF THE DRAWINGS

FIG. 1 is a schematic perspective view of an imaging apparatus.

FIG. 2 is a diagram illustrating an example of an internal configuration of the imaging apparatus.

FIG. 3 is a block diagram illustrating an example of a functional configuration of a processor.

FIG. 4 is a diagram illustrating an example of a configuration of a shake correction controller.

FIG. 5 is a diagram for describing an example of electronic anti-vibration processing.

FIG. 6 is a diagram illustrating examples of an angular velocity signal and movement of a recording region during a camera shake.

FIG. 7 is a diagram illustrating examples of the angular velocity signal and movement of the recording region during a panning operation.

FIG. 8 is a diagram schematically illustrating an example of a change in the recording region during the panning operation.

FIG. 9 is a diagram illustrating examples of a first correction function and a second correction function.

FIG. 10 is a diagram illustrating changes in correction strength corresponding to the first correction function and the second correction function.

FIG. 11 is a diagram conceptually illustrating an example of shake correction in a case where the first correction function is applied.

FIG. 12 is a diagram conceptually illustrating an example of the shake correction in a case where a correction function compared to FIG. 11 is applied.

FIG. 13 is a diagram conceptually illustrating an example of a restoration time in a case where the first correction function is applied.

FIG. 14 is a diagram conceptually illustrating an example of the restoration time in a case where the second correction function is applied.

FIG. 15 is a flowchart for describing an example of the shake correction.

FIG. 16 is a diagram illustrating the second correction function of a first modification example.

FIG. 17 is a diagram illustrating a change in the correction strength corresponding to the second correction function of the first modification example.

FIG. 18 is a diagram illustrating an example of a flowchart of a second modification example.

FIG. 19 is a diagram schematically illustrating an example in which the recording region does not change during the panning operation.

FIG. 20 is a flowchart of a third modification example.

### DETAILED DESCRIPTION

An example of an embodiment according to the disclosed technology will be described in accordance with the accompanying drawings.

### Configuration of Imaging Apparatus

The disclosed technology will be described using an example of a lens-interchangeable digital camera as a first embodiment of an imaging apparatus. The disclosed technology is not limited to the lens-interchangeable digital camera and is also applicable to a lens-integrated digital camera.

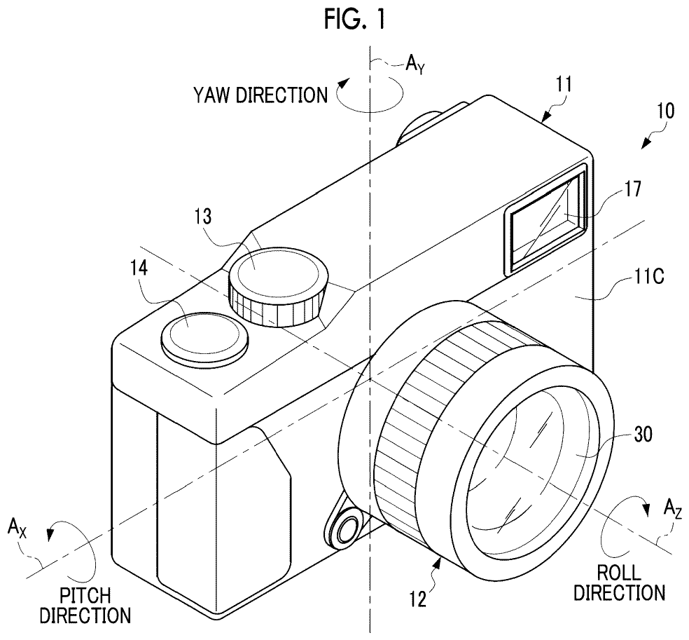

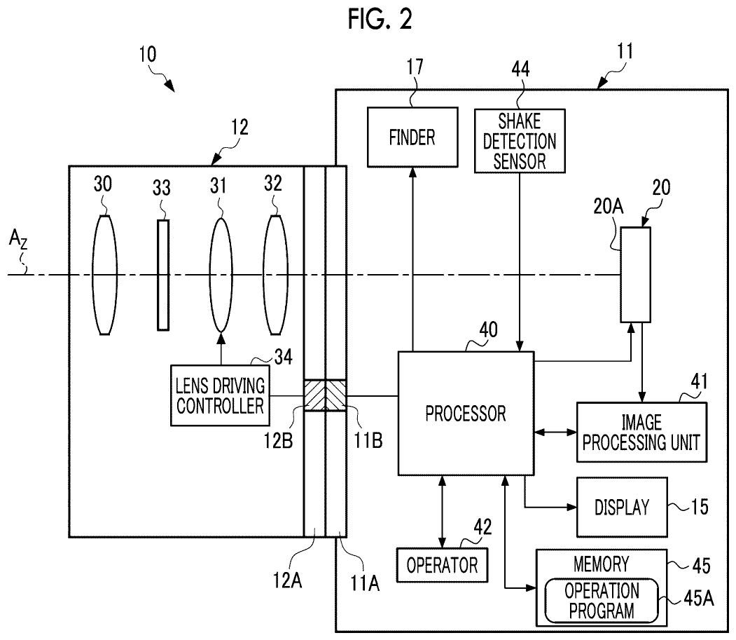

FIG. 1 illustrates a perspective view of an imaging apparatus 10. As illustrated in FIG. 1, the imaging apparatus 10 is a lens-interchangeable digital camera. The imaging apparatus 10 is composed of a body 11 and an imaging lens 12 interchangeably mounted on the body 11. The imaging lens 12 is attached to a side of the body 11 on a front surface 11C through a camera-side mount 11A and a lens-side mount 12A (see FIG. 2). The imaging lens 12 is an example of a lens according to the disclosed technology.

A dial 13 and a release button 14 constituting an operator 42 (see FIG. 2) are provided on an upper surface of the body 11. The dial 13 is operated to set an operation mode or the like. The operation mode of the imaging apparatus 10 includes, for example, a still image capturing mode, a moving image capturing mode, and an image display mode. The release button 14 is operated by a user to start executing still image capturing or moving image capturing.

The body 11 is provided with a finder 17. Here, the finder 17 is a Hybrid Finder (registered trademark). The Hybrid Finder refers to a finder in which, for example, an optical view finder (hereinafter, referred to as the “OVF”) and an electronic view finder (hereinafter, referred to as the “EVF”) are selectively used.

A Z axis A_{Z} illustrated in FIG. 1 corresponds to an optical axis of the imaging lens 12. An X axis A_{X} and a Y axis A_{Y} are orthogonal to each other and orthogonal to the Z axis A_{Z}. The X axis A_{X} and the Y axis A_{Y} correspond to a pitch axis and a yaw axis according to the disclosed technology. In the following description, a rotation direction about the Z axis A_{Z} will be referred to as a roll direction. A rotation direction about the X axis A_{X} will be referred to as a pitch direction. A rotation direction about the Y axis A_{Y} will be referred to as a yaw direction. A direction of the X axis A_{X} will be referred to as an X direction, and a direction of the Y axis A_{Y} will be referred to as a Y direction. The term “orthogonal” includes not only being orthogonal at an angle of 90° but also being substantially orthogonal in the sense including an error generally allowed in the technical field to which the disclosed technology belongs.

A display 15, an instruction key (not illustrated), and a finder eyepiece portion (not illustrated) are provided on a rear surface of the body 11 of the imaging apparatus 10. The display 15 displays images based on an image signal obtained through imaging and various menu screens and the like.

The instruction key also constitutes the operator 42 (see FIG. 2) and receives various instructions. Here, the “various instructions” include, for example, an instruction to display a menu screen on which various menus can be selected, an instruction to select one or a plurality of menus, an instruction to confirm selected contents, an instruction to cancel the selected contents, and various instructions for an autofocus mode, a manual focus mode, and frame advance. The body 11 is also provided with a power switch and the like.

An optical image visible through the OVF and a live view image that is an electronic image visible through the EVF are selectively displayed on the finder eyepiece portion. The user can observe an optical image or a live view image of a subject through the finder eyepiece portion.

FIG. 2 illustrates an example of an internal configuration of the imaging apparatus 10. The body 11 and the imaging lens 12 are electrically connected by bringing an electrical contact 11B provided in the camera-side mount 11A and an electrical contact 12B provided in the lens-side mount 12A into contact with each other.

The imaging lens 12 includes an objective lens 30, a focus lens 31, a rear end lens 32, and a stop 33. These optical elements are arranged in the order of the objective lens 30, the stop 33, the focus lens 31, and the rear end lens 32 from an objective side along the optical axis of the imaging lens 12 (that is, the Z axis A_{Z}). The objective lens 30, the focus lens 31, and the rear end lens 32 constitute an imaging optical system. Types, numbers, and arrangement orders of lenses constituting the imaging optical system are not limited to the example illustrated in FIG. 2.

The imaging lens 12 includes a lens driving controller 34 and a memory (not illustrated). The lens driving controller 34 is composed of, for example, a central processing unit (CPU), a random access memory (RAM), and a read only memory (ROM). The lens driving controller 34 is electrically connected to a processor 40 in the body 11 through the electrical contact 12B and the electrical contact 11B.

The lens driving controller 34 drives the focus lens 31 and the stop 33 based on control signals transmitted from the processor 40. The lens driving controller 34 performs a drive control of the focus lens 31 based on a control signal for focus control transmitted from the processor 40 to adjust a focus position of the imaging lens 12. The processor 40 performs the focus control using, for example, a phase difference method.

The stop 33 includes an opening of which an opening diameter is variable about the optical axis. The lens driving controller 34 performs a drive control of the stop 33 based on a control signal for stop adjustment transmitted from the processor 40 to adjust an amount of an incidence ray on a light-receiving surface 20A of an imaging sensor 20.

The imaging lens 12 is provided with a memory (not illustrated). The memory is a non-volatile memory such as a flash memory. The memory stores, for example, lens data for identifying a type of the imaging lens 12. The lens data includes, for example, information indicating a focal length (that is, a zoom magnification) of the imaging lens 12.

The body 11 includes the imaging sensor 20, the processor 40, an image processing unit 41, the operator 42, and the display 15. Operations of the imaging sensor 20, the image processing unit 41, the operator 42, a shake detection sensor 44, and the display 15 are controlled by the processor 40. The processor 40 is composed of, for example, a CPU, a RAM, and a ROM. In this case, the processor 40 executes various types of processing based on an operation program 45A stored in a memory 45. The processor 40 may be composed of a set of a plurality of integrated circuit (IC) chips.

The imaging sensor 20 is, for example, a complementary metal oxide semiconductor (CMOS) image sensor. The imaging sensor 20 is disposed such that the Z axis A_{Z} as the optical axis is orthogonal to the light-receiving surface 20A, and the Z axis A_{Z} is positioned at the center of the light-receiving surface 20A. Light that has passed through the imaging lens 12 is incident on the light-receiving surface 20A. A plurality of pixels that generate the image signal by performing photoelectric conversion are formed on the light-receiving surface 20A. The imaging sensor 20 generates and outputs the image signal by photoelectrically converting the light incident on each pixel.

The shake detection sensor 44 detects a shake applied to the body 11 accommodating the imaging sensor 20. The shake includes a camera shake in a case where the imaging apparatus 10 is held by a hand. The shake detection sensor 44 is, for example, a five-axis shake detection sensor that detects a shake in each of the roll direction, the yaw direction, the pitch direction, the X direction, and the Y direction. Hereinafter, the shake in the roll direction will be referred to as a rotational shake. The shake in the yaw direction and the pitch direction will be referred to as an angular shake. The shake in the X direction and the Y direction will be referred to as a translational shake.

The shake detection sensor 44 is composed of, for example, a gyro sensor and an acceleration sensor. The gyro sensor detects the rotational shake and the angular shake. The acceleration sensor detects the translational shake.

The image processing unit 41 is composed of, for example, a digital signal processor (DSP). The image processing unit 41 generates image data in a predetermined file format (for example, a joint photographic experts group (JPEG) format) by performing various types of image processing on the image signal.

The display 15 displays images based on the image data generated by the image processing unit 41. The images include a still image, a moving image, and the live view image. The live view image is an image that is displayed in real time on the display 15 by sequentially outputting the image data generated by the image processing unit 41 to the display 15.

The image data generated by the image processing unit 41 can be stored in an internal memory (not illustrated) incorporated in the body 11 or a storage medium (for example, a memory card) attachable to and detachable from the body 11.

The processor 40 controls each unit in the body 11 and the lens driving controller 34 in the imaging lens 12 in accordance with an operation of the operator 42.

In a case where the imaging lens 12 is connected to the body 11, the processor 40 acquires the lens data through the lens driving controller 34.

The camera-side mount 11A is provided on the front surface 11C of the body 11. The imaging lens 12 is provided with the lens-side mount 12A on its rear end side. The imaging lens 12 is connected to the body 11 by attaching the lens-side mount 12A to the camera-side mount 11A.

In the imaging sensor 20, the light-receiving surface 20A is exposed from an opening of the camera-side mount 11A. In a case where the imaging lens 12 is mounted on the body 11, the imaging lens 12 forms an image of the light from the subject on the light-receiving surface 20A of the imaging sensor 20. The imaging sensor 20 generates and outputs the image signal by imaging the light of the image formed on the light-receiving surface 20A.

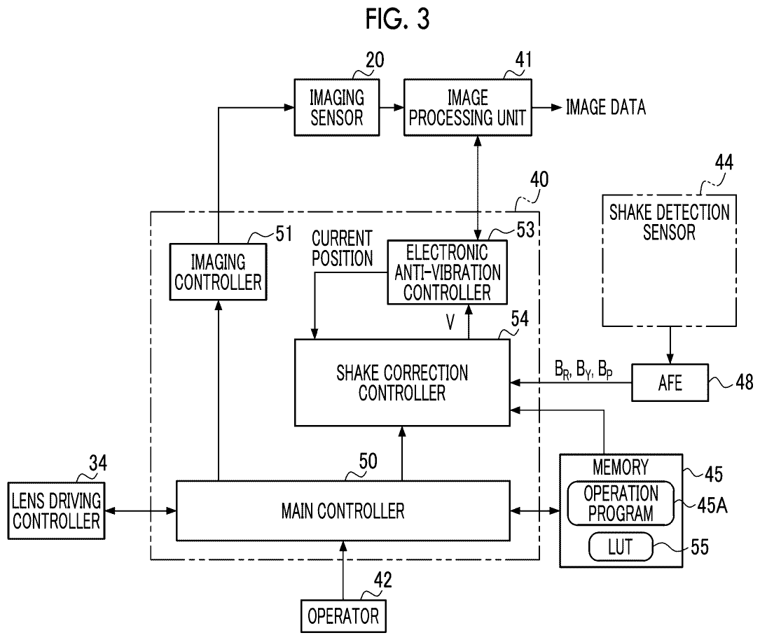

FIG. 3 illustrates an example of a functional configuration of the processor 40. The processor 40 implements various functional units by executing processing in accordance with the operation program 45A stored in the memory 45. As illustrated in FIG. 3, for example, the processor 40 implements a main controller 50, an imaging controller 51, and a shake correction controller 54.

The main controller 50 controls the operation of the imaging sensor 20 in an integrated manner based on an instruction signal input from the operator 42. The imaging controller 51 controls an imaging operation of the imaging sensor 20. The imaging controller 51 drives the imaging sensor 20 in the still image capturing mode or the moving image capturing mode.

The user can make a selection between the still image capturing mode and the moving image capturing mode and various settings in an imaging mode by operating the operator 42. The imaging controller 51 executes drive processing of driving the imaging sensor 20 in accordance with a selected imaging mode and a selected setting.

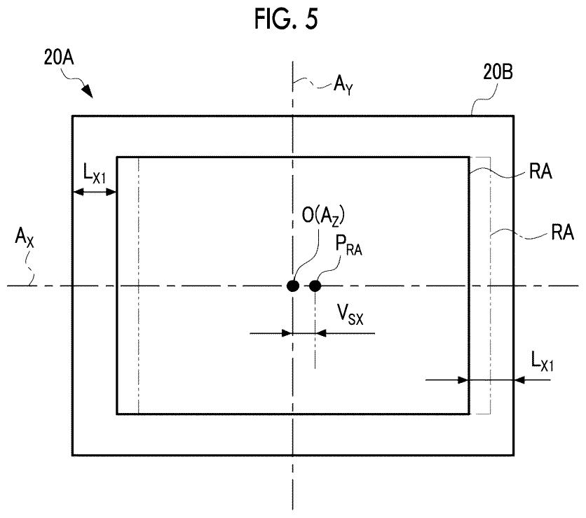

An electronic anti-vibration controller 53 executes electronic anti-vibration processing of correcting the rotational shake and the translational shake by controlling the image processing unit 41. As will be described in detail later, in the electronic anti-vibration processing, the rotational shake and the translational shake are corrected by changing a recording region RA (see FIG. 5) for recording the image signal from an imaging region 20B of the imaging sensor 20 between frames. The electronic anti-vibration processing corresponds to a shake correction method of an “electronic correction method” according to the disclosed technology. The electronic anti-vibration processing is shake correction processing of correcting the shake by moving the recording region RA in the imaging region 20B. The recording region RA is an example of a “target to be moved” according to the disclosed technology. In the recording region RA, the image processing unit 41 generates the image data by performing image processing on a signal corresponding to the recording region in the image signal. That is, the recording region RA is a cutout position in the imaging region 20B of the image signal for generating the image data and is an example of an “image cutout position” according to the disclosed technology. The change in the recording region RA includes rotation and translation of the recording region RA. Such electronic anti-vibration processing reduces a decrease in image quality caused by the shake applied to the body 11.

In the shake detection sensor 44, the gyro sensor is an angular velocity sensor that detects the rotational shake and the angular shake, and outputs angular velocity signals as a detection value. The gyro sensor outputs an angular velocity signal B_{R} indicating the rotational shake and angular velocity signals B_{Y} and B_{P} indicating the angular shake. The angular velocity signal B_{Y} indicates the angular shake in the yaw direction. The angular velocity signal B_{P} indicates the angular shake in the pitch direction. In the shake detection sensor 44, the acceleration sensor outputs acceleration signals as a detection value of the translational shake. The acceleration sensor outputs an acceleration signal indicating the translational shake in the X direction and an acceleration signal indicating the translational shake in the Y direction. The angular velocity signals and the acceleration signals output by the shake detection sensor 44 are examples of displacement information according to the disclosed technology. The displacement information is information including a direction and a magnitude of displacement of the imaging apparatus 10. The displacement of the imaging apparatus 10 also includes vibration.

The angular velocity signals B_{R}, B_{Y}, and B_{P} output from the gyro sensor are input into the shake correction controller 54 through an analog front end (AFE) 48 composed of an A/D converter, an amplifier, and the like. The acceleration signals output from the acceleration sensor are input into the shake correction controller 54 through the AFE 48.

In the present embodiment, there are five detection axes of the shake including the roll direction, the yaw direction, the pitch direction, the X direction, and the Y direction, and there are three correction axes of the shake including the roll direction, the X direction, and the Y direction. Thus, in the yaw direction and the pitch direction, the angular shake cannot be directly corrected based on the angular velocity signals B_{Y} and B_{P} indicating the angular shake. In the present embodiment, the angular shake in the yaw direction is corrected while correcting the translational shake in the X direction, and the angular shake in the pitch direction is corrected while correcting the translational shake in the Y direction.

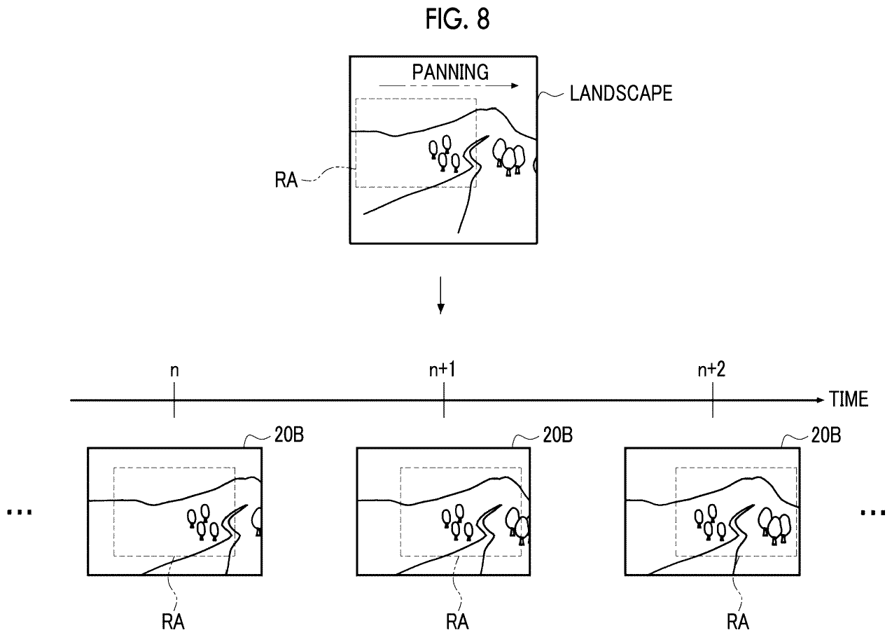

Hereinafter, the shake in the yaw direction among the shakes along the five axes will be mainly described. The shake in the yaw direction is caused by the camera shake and is also caused by a panning operation that is one of types of camerawork through which the user intentionally moves the imaging apparatus 10. As is well known, the panning operation is an operation of changing an orientation of an imaging direction of the imaging apparatus 10 in one direction of a left-to-right direction at an almost constant speed while keeping a height of the imaging apparatus 10 almost constant. The panning operation is, for example, a type of camerawork performed for the purpose of panoramically imaging a landscape (see FIG. 8) or panning to follow a moving object such as a vehicle.

The memory 45 stores a look-up table (hereinafter, referred to as the LUT) 55. The LUT 55 is a table in which a correction function for deriving a correction amount in the shake correction is recorded.

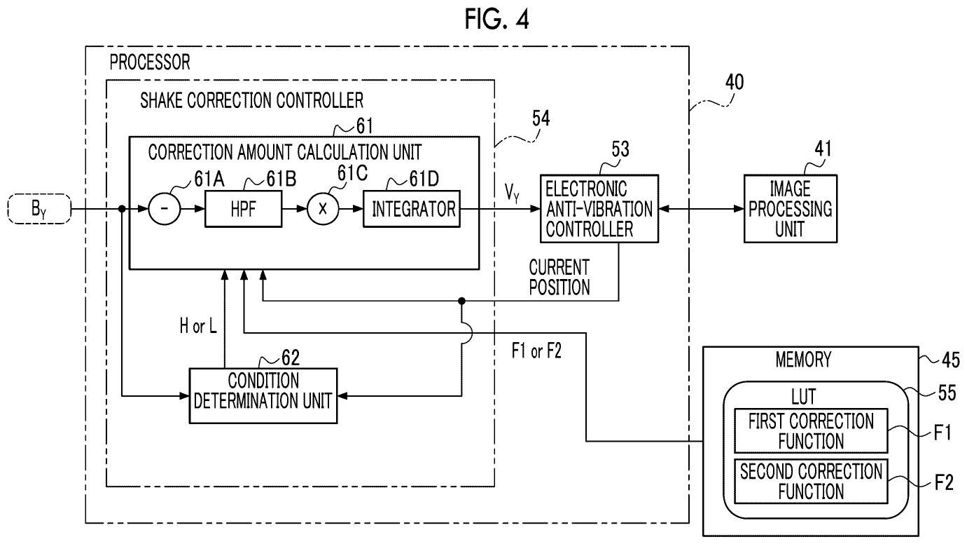

FIG. 4 illustrates an example of a configuration of the shake correction controller 54. FIG. 4 illustrates a configuration related to correction of the angular shake in the yaw direction. The shake correction controller 54 comprises a correction amount calculation unit 61 that calculates a correction amount V_{Y} in the yaw direction based on the angular velocity signal B_{Y} in the yaw direction, and a condition determination unit 62.

The correction amount calculation unit 61 converts the angular velocity signal B_{Y} indicating the angular shake in the yaw direction into the correction amount V_{Y} indicating angular information and outputs the correction amount V_{Y}. The correction amount calculation unit 61 includes, for example, a subtractor 61A, a high-pass filter (hereinafter, referred to as the HPF) 61B, a multiplier 61C, and an integrator 61D.

The subtractor 61A performs offset correction by subtracting a zero-point correction value from the angular velocity signal B_{Y}. The zero-point correction value is an output value from the gyro sensor in a case where the gyro sensor is at a standstill. The HPF 61B removes at least a part of a remaining direct current component that is not removed through the offset correction using the subtractor 61A.

As will be described in detail later, a cutoff frequency for removing the direct current component in the HPF 61B is not constant, and the cutoff frequency of the HPF 61B is changed in accordance with a determination result of the condition determination unit 62 and the correction function stored as the LUT 55.

The multiplier 61C performs gain correction by multiplying an output signal from the HPF 61B by a gain value. The gain value is a value determined by the focal length of the imaging lens 12 and/or sensitivity of the gyro sensor. For example, in a case where the focal length of the imaging lens 12 changes, the correction amount in the imaging region 20B varies even for the shake having the same angle. In the rotational shake in the roll direction, the gain value does not depend on the focal length of the imaging lens 12. The integrator 61D generates and outputs the correction amount V_{Y} indicating the angular information by integrating an output signal from the multiplier 61C. The correction amount calculation unit 61 outputs the calculated correction amount V_{Y} to the electronic anti-vibration controller 53.

The correction amount V_{Y} corresponds to the angle in the yaw direction. The electronic anti-vibration controller 53 converts the correction amount V_{Y} into a correction amount V_{SX} in the X direction to correct the angular shake in the yaw direction to the translational shake in the X direction.

As illustrated in FIG. 5, the imaging region 20B includes the recording region RA that is an image cutout region for cutting out the image data, and sizes of the imaging region 20B in the X direction and the Y direction are greater than those of the recording region RA. An electronic anti-vibration control is a control of reducing the shake by changing a position of the recording region RA in the imaging region 20B in accordance with a magnitude and an orientation of the shake. In an initial state, a center O of the imaging region 20B and a center P_{RA} of the recording region RA coincide with each other. In correcting the angular shake in the yaw direction, the position of the recording region RA is shifted in the X direction. The correction amount V_{SX} corresponds to a shift amount for shifting the position of the recording region RA in the X direction in the imaging region 20B. In FIG. 5, L_{X1} denotes the maximum shift amount by which the recording region RA can be shifted. The electronic anti-vibration controller 53 feeds the current position of the recording region RA back to the correction amount calculation unit 61.

While an expression such that the position of the recording region RA is at the center O will be used below, this means that the center P_{RA} of the recording region RA coincides with the center O of the imaging region 20B. In a case where the position of the recording region RA is not at the center O, this means that the center P_{RA} of the recording region RA does not coincide with the center O of the imaging region 20B and is separated from the center O.

In FIG. 4, each of a first correction function F1 and a second correction function F2 is stored in the memory 45 in the form of the LUT 55 as the correction function for deriving the correction amount in the shake correction. In a case where the displacement information related to the angle of the shake output by the shake detection sensor 44 satisfies a predetermined condition, and the position of the recording region RA which is the target to be moved is not at the center O, the shake correction controller 54 determines the correction amount of the recording region RA using the second correction function F2 of which a restoration time TR is shorter than that of the first correction function F1, instead of the first correction function F1.

The condition determination unit 62 determines a condition for applying the second correction function F2. The condition determination unit 62 outputs an H signal in a case where a condition set in advance is satisfied and the position of the recording region RA is not at the center O, or otherwise outputs an L signal. The correction amount calculation unit 61 selects the first correction function F1 while the L signal is input, and selects the second correction function F2 instead of the first correction function F1 in a case where the H signal is input. As will be described later, the condition determination unit 62 determines the condition based on the angular velocity signal B_{Y} which is an example of the displacement information of the imaging apparatus 10. Thus, the angular velocity signal B_{Y} is also input into the condition determination unit 62.

Actions of the first correction function F1 and the second correction function F2 in the shake correction and a reason for performing the shake correction using two correction functions will be described below.

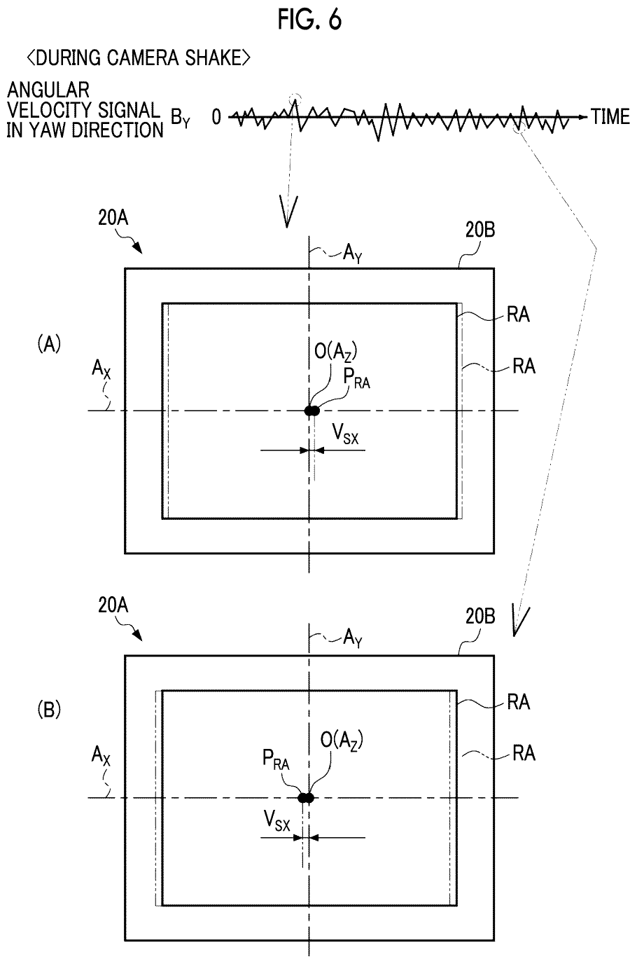

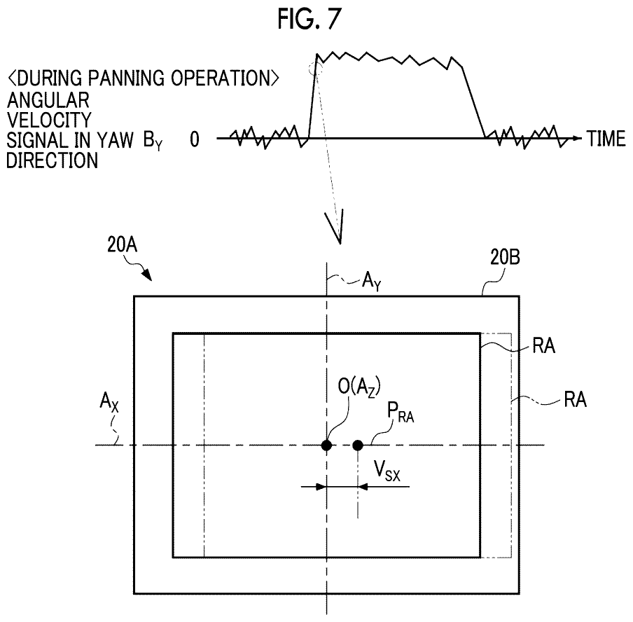

First, the camera shake and the panning operation related to the angular shake in the yaw direction will be described with reference to FIGS. 6 to 8. FIG. 6 illustrates the angular velocity signal B_{Y} in the yaw direction during the camera shake and the correction amount V_{SX} of the corresponding recording region RA. FIG. 7 illustrates the angular velocity signal B_{Y} in the yaw direction during the panning operation and the correction amount V_{SX} of the corresponding recording region RA. As illustrated in FIGS. 6 and 7, the angular velocity signal B_{Y} during the camera shake has a low angular velocity and a high frequency. Meanwhile, the angular velocity signal B_{Y} during the panning operation has a high angular velocity and a low frequency. During the camera shake, a direction of the displacement changes, and vibration occurs. During the panning operation, a period in which the direction of the displacement is one direction is long. Thus, the angular velocity signal B_{Y} during the panning operation has a large amount of the direct current component.

Thus, as illustrated in FIG. 6, the correction amount V_{SX} for the shake correction during the camera shake is relatively small and is generated in a positive direction and a negative direction in the X direction. Meanwhile, as illustrated in FIG. 7, the correction amount V_{SX} for the shake correction during the panning operation is relatively large and is generated in one direction of the positive direction or the negative direction in the X direction.

FIG. 8 conceptually illustrates the panning operation in panoramically capturing a moving image of a landscape of a mountain, and the shake correction in this case. FIG. 8 illustrates three frames of an n-th frame to (n+2)-th frame that are switched as time passes in the panning operation. In the panning operation, the detected angular velocity is increased. Thus, the correction amount V_{SX} is increased, and the shift amount of the recording region RA is likely to reach the maximum shift amount during the panning operation. The meaning of the shift amount reaching the maximum shift amount indicates that the recording region RA reaches a correction limit, and this leads to a state where further correction cannot be performed. In a case where the recording region RA reaches the correction limit in the moving image capturing mode, a motion of the moving image may not be natural, such as an unsmooth motion.

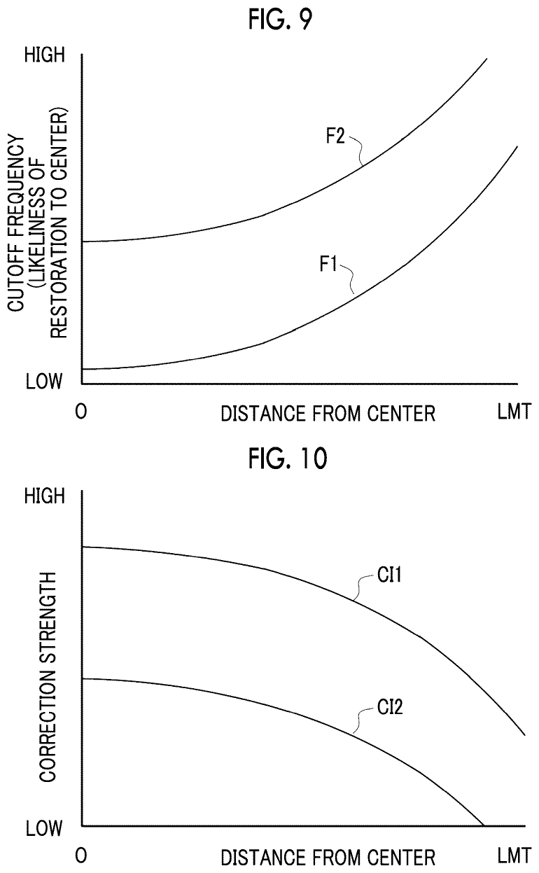

FIG. 9 illustrates examples of the first correction function F1 and the second correction function F2. As described above, the imaging apparatus 10 implements the shake correction by moving the recording region RA in the imaging region 20B. The first correction function F1 and the second correction function F2 are functions that change the cutoff frequency of the HPF 61B in accordance with a change in the position of the recording region RA, which is the target to be moved, in the shake correction. FIG. 10 illustrates a first correction curve CI1 and a second correction curve CI2 showing changes in correction strength corresponding to the first correction function F1 and the second correction function F2, respectively. The cutoff frequency of the HPF 61B has a negative correlation with the correction strength of the shake correction. The correction strength is decreased as the cutoff frequency is increased, and the correction strength is increased as the cutoff frequency is decreased. Both of the first correction function F1 and the second correction function F2 are functions in which the correction strength is decreased as the position of the recording region RA which is the target to be moved comes closer to the correction limit (denoted by reference numeral LMT in FIG. 9) from the center O, in other words, as the position of the recording region RA is separated from the center O of the imaging region 20B.

High correction strength indicates unlikeliness of restoration of the recording region RA to the center O. Thus, a magnitude of the cutoff frequency in the first correction function F1 and the second correction function F2 indicates likeliness of restoration to the center O.

In a case where such a correction function is used, for example, even in a case where a magnitude of the angular velocity signal B_{Y} in the yaw direction is the same, the correction amount is increased in a case where the position of the recording region RA is close to the center O of the imaging region 20B, as in the n-th frame illustrated in FIG. 8. Meanwhile, the correction amount can be decreased in a case where the position of the recording region RA comes closer to the correction limit, as in the (n+2)-th frame.

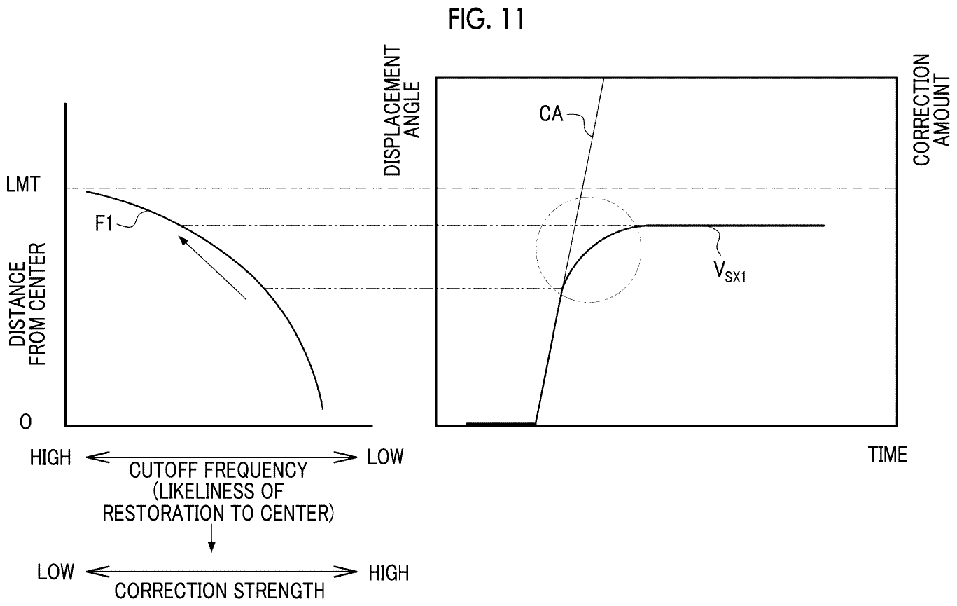

FIG. 11 illustrates a change in the correction amount V_{SX1} near the correction limit in a case where the first correction function F1 is applied in the panning operation. As illustrated in FIG. 11, in a case where a displacement angle CA of the imaging apparatus 10 indicating the angle of the shake in the yaw direction is increased, the magnitude of the angular velocity signal B_{Y} in the yaw direction is increased. Thus, for example, in the initial state where the panning operation of the imaging apparatus 10 starts, that is, in a case where the position of the recording region RA is close to the center O, a correction amount V_{SX1} changes relatively linearly with respect to a change in the displacement angle CA. However, in a case where the recording region RA comes closer to the correction limit, an inclination of the change in the correction amount V_{SX1} decreases gradually. Accordingly, the motion of the moving image is smooth.

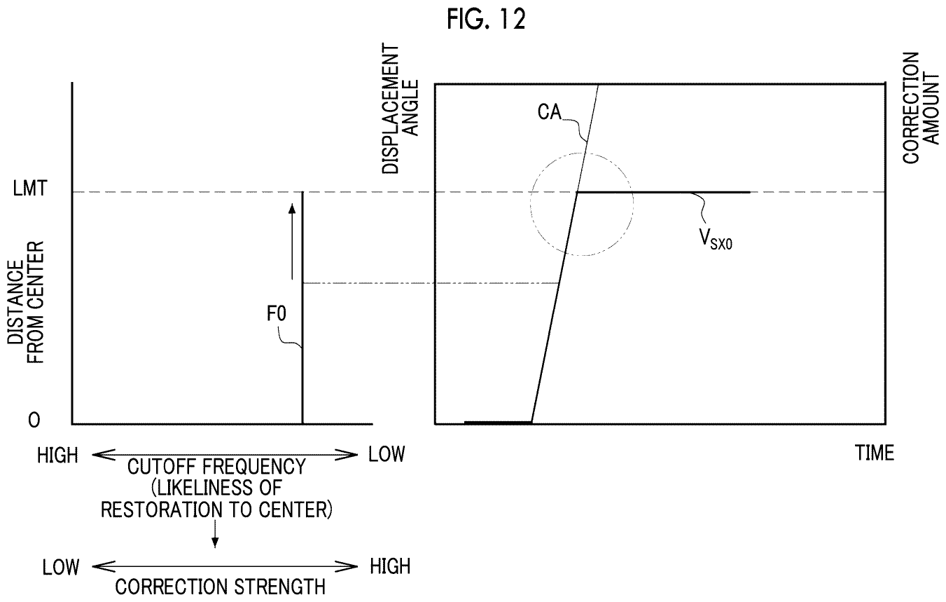

FIG. 12 illustrates a change in a correction amount V_{SX0} in a case where a correction function F0 having a constant cutoff frequency regardless of the position of the recording region RA is applied. In a case where the correction function F0 having the constant cutoff frequency is applied, an inclination of a change in the correction amount V_{SX0} is constant in a case where an inclination of the displacement angle CA is constant while the position of the recording region RA changes from the center O to the correction limit in the panning operation. In this case, the recording region RA is likely to reach the correction limit, and the motion of the moving image is not smooth and results in an unnatural motion.

By performing the shake correction using the first correction function F1, the motion of the moving image near the correction limit can be smoothed, as illustrated in FIG. 11. However, in a case where only the first correction function F1 is used, the following disadvantages arise.

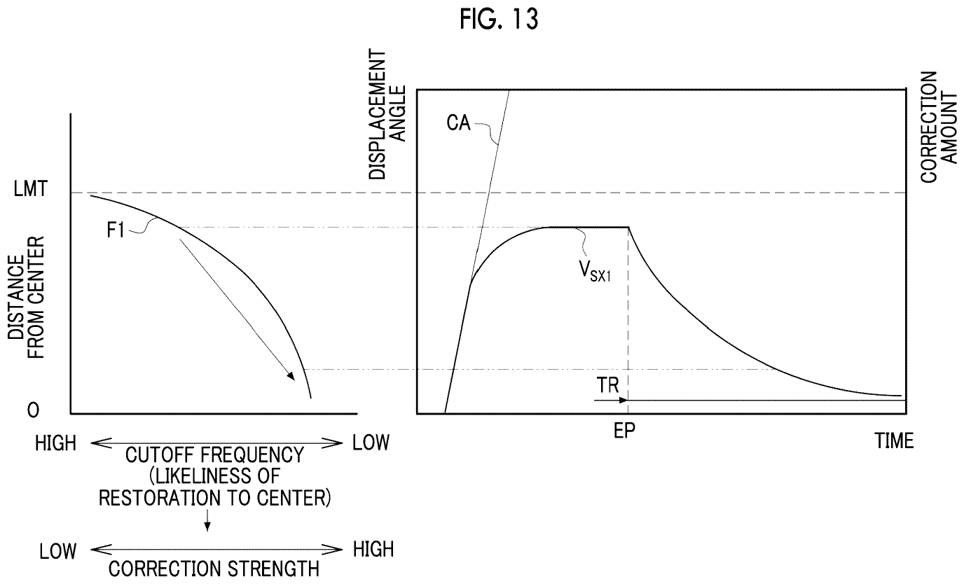

FIG. 13, like FIG. 11, illustrates a change in the correction amount V_{SX1} in a case where the first correction function F1 is applied. However, FIG. 13 illustrates a state where the correction amount V_{SX1} is reduced from a time point EP at which the panning operation is finished, until the recording region RA is restored to the center O of the imaging region 20B. The first correction function F1 is a function in which the correction strength is increased as the recording region RA comes closer to the center O. In other words, this means that, as the recording region RA comes closer to the center O, the recording region RA is more unlikely to be restored to the center O, and the restoration time TR in which the recording region RA is restored to the center O from the time point EP at which the panning operation is finished is increased. Considering the shake correction caused by the camera shake, it is preferable to set a state where the position of the recording region RA is as close as possible to the center O, and the shift amount in which the recording region RA can move is secured. Thus, the restoration time TR in which the recording region RA is restored to the center O is preferably as short as possible.

While the first correction function F1 has an advantage of a smooth motion of the moving image in a case where the recording region RA is close to the correction limit as illustrated in FIG. 11, the first correction function F1 has a disadvantage of an increase in the restoration time TR in which the recording region RA is restored to the center O as illustrated in FIG. 13. The imaging apparatus 10 has the second correction function F2 in addition to the first correction function F1 to compensate for such a disadvantage of the first correction function F1.

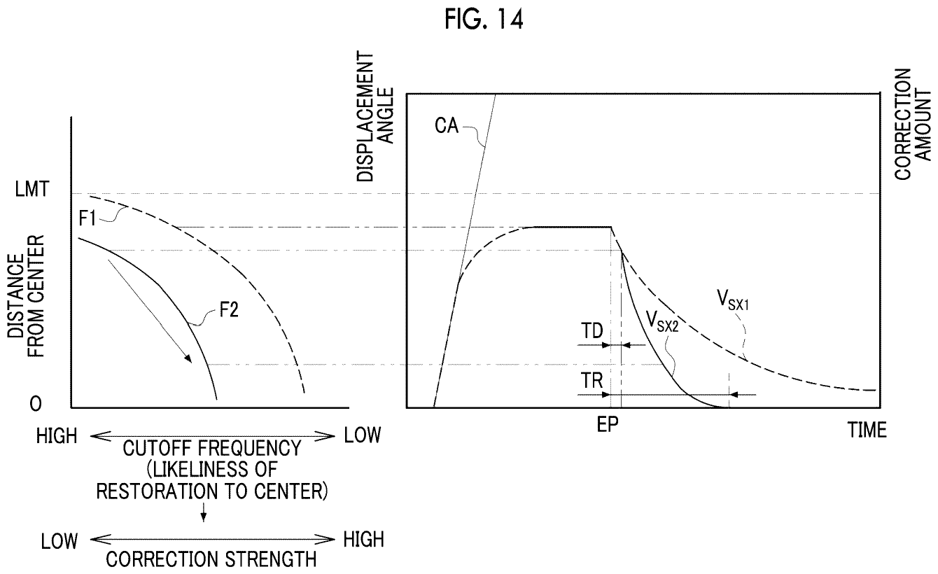

As illustrated in FIG. 14, the second correction function F2 is a function in which the restoration time TR of the recording region RA, which is the target to be moved, to the center O is shorter than that of the first correction function F1. The second correction function F2, like the first correction function F1, is a function in which the correction strength is decreased as the position of the recording region RA is separated from the center O. However, the cutoff frequency of the second correction function F2 is relatively higher than that of the first correction function F1 in the whole range from the center O to the correction limit. Accordingly, the correction strength of the second correction function F2 is lower than that of the first correction function F1. Low correction strength means likeliness of restoration to the center O. Thus, an inclination at which a correction amount V_{SX2} of the second correction function F2 is reduced is greater than that of the first correction function F1, and the restoration time TR of the second correction function F2 is shorter than that of the first correction function F1.

As described above, in a case where the displacement information related to the angle of the shake satisfies the predetermined condition, and the position of the recording region RA which is the target to be moved is not at the center O, the shake correction controller 54 determines the correction amount of the recording region RA using the second correction function F2 of which the restoration time TR is shorter than that of the first correction function F1, instead of the first correction function F1. The second correction function F2 is used for reducing the restoration time TR. Thus, for example, the condition set in advance indicates that the panning operation is finished and a time TD set in advance elapses.

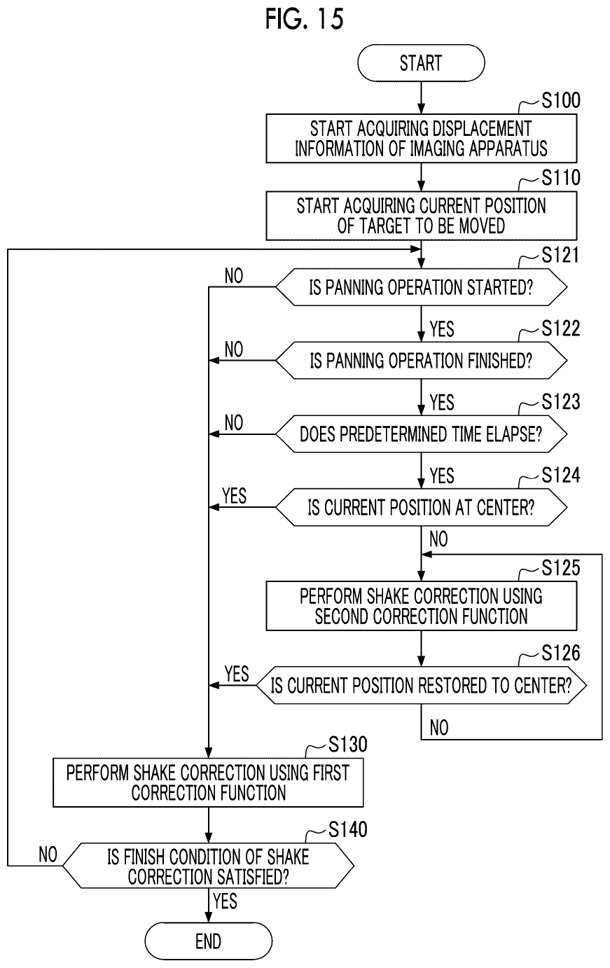

An action of the above configuration will be described with reference to the flowchart illustrated in FIG. 15. In the flowchart illustrated in FIG. 15, the angular shake in the yaw direction will be illustratively described for simplification of description. In a case where the moving image capturing mode is executed by switching the shake correction based on the electronic anti-vibration processing ON, the processor 40 starts acquiring the displacement information of the imaging apparatus 10 from the shake detection sensor 44 in step S100. In step S110, the processor 40 starts acquiring the current position of the recording region RA which is the target to be moved. The displacement information during the angular shake in the yaw direction is the angular velocity signal B_{Y}, and the current position is the position of the recording region RA in the X direction in the imaging region 20B.

In step S121, the processor 40 determines whether or not the panning operation is started based on the angular velocity signal B_{Y} which is the displacement information. As illustrated in FIGS. 6 and 7, the angular velocity of the angular velocity signal B_{Y} during the panning operation is higher than that during the camera shake, and a time in which the angular velocity is high continues relatively long. Thus, as a method of determining the panning operation, for example, it is determined that the panning operation is performed in a case where the angular velocity greater than or equal to a threshold value set in advance continues for a time greater than or equal to a threshold value set in advance. Alternatively, since the direction of the displacement is one direction in the panning operation unlike that in the camera shake, it may be determined that the panning operation is performed in a case where the angular velocity generated in the same direction continues for the time greater than or equal to the threshold value set in advance.

In a case where it is determined that the panning operation is not performed (NO in step S121), the processor 40 transitions to step S130 and performs the shake correction using the first correction function F1. By performing the shake correction using the first correction function F1, the shake caused by the camera shake is appropriately corrected. In addition, as illustrated in FIG. 11, in a case where the position of the recording region RA is close to the correction limit, the motion of the moving image can be smoothed.

Meanwhile, in a case where it is determined that the panning operation is performed (YES in step S121), the processor 40 transitions to step S122 and determines whether or not the panning operation is finished. For example, the finish of the panning operation is determined by the fact that the angular velocity signal B_{Y} at a constant level during the panning operation starts decreasing continuously. The processor 40 determines that the panning operation is finished, and then transitions to step S123. In step S123, the processor 40 starts tracking time via a timer from the time point EP at which it is determined that the panning operation is finished, and determines whether or not the predetermined time TD elapses. In a case where the predetermined time TD elapses (YES in step S123), the processor 40 transitions to step S124. In step S124, the processor 40 determines whether or not the position of the recording region RA is at the center O of the imaging region 20B. In a case where the position of the recording region RA is not at the center O (NO in step S124), the processor 40 transitions to step S125 and performs the shake correction using the second correction function F2.

Steps S122 to S124 are steps of determining the condition for applying the second correction function F2. In a case where these conditions are not satisfied (NO in step S122, NO in step S123, or YES in step S124), a transition is made to step S130, and the shake correction using the first correction function F1 continues.

While the shake correction using the second correction function F2 is executed, the processor 40 monitors whether or not the current position of the recording region RA is restored to the center O in step S126. In step S126, while it is determined that the current position of the recording region RA is not restored to the center (NO in step S126), the processor 40 executes the shake correction using the second correction function F2. Since the shake correction using the second correction function F2 instead of the first correction function F1 is performed, the restoration time TR of the recording region RA to the center O is shorter than that in a case where the first correction function F1 is used, as illustrated in FIG. 14.

In step S126, in a case where it is determined that the recording region RA is restored to the center O, the processor 40 transitions to step S130 and restores the second correction function F2 to the first correction function F1. By restoring to the first correction function F1 in a case where the panning operation is finished and the recording region RA is restored to the center O, the shake caused by the camera shake can be appropriately corrected.

In step S140, the processor 40 determines the finish of the moving image capturing mode or a finish condition of the shake correction indicating that the shake correction is switched OFF, and repeats processing of steps S121 to S130 until the finish condition of the shake correction is satisfied.

As described above, the imaging apparatus 10 according to the disclosed technology comprises the processor 40, and the processor 40 acquires the displacement information including the orientation and the magnitude of the displacement and positional information of the recording region RA (an example of the target to be moved) that is moved for camera shake correction, and in a case where the displacement information satisfies the predetermined condition, and the position of the target to be moved is not at the center O (an example of a predetermined position), determines the correction amount of the recording region RA using the second correction function F2 of which the restoration time TR of the recording region RA to the center O is shorter than that of the first correction function F1, instead of the first correction function F1. Accordingly, the restoration time of the target to be moved to the predetermined position can be reduced under the condition set in advance.

In the above embodiment, the predetermined condition includes a condition that the panning operation is finished and the time set in advance elapses. A case where the panning operation is finished is considered to be an example of a case where the shake correction is not necessary. In this case, the target to be moved for the camera shake correction can be quickly restored to the predetermined position.

In the above embodiment, during the panning operation, the processor 40 determines the correction amount using the first correction function F1. Thus, the correction strength can be increased until the panning operation is finished.

In a case where the recording region RA (an example of the target to be moved) is restored to the center O (an example of the predetermined position), the processor 40 restores the second correction function F2 to the first correction function F1. Thus, correction using the first correction function F1 can be performed in a case where the recording region RA is restored to the center O after the finish of the panning operation.

Both of the first correction function F1 and the second correction function F2 are functions in which the correction strength is decreased as the position of the recording region RA (an example of the target to be moved) is separated from the center O (an example of the predetermined position). Thus, in performing the shake correction, since movement of the recording region RA is smoothed as coming closer to the correction limit, the motion of the moving image can be smoothed.

### First Modification Example: Modification Example of Second Correction Function

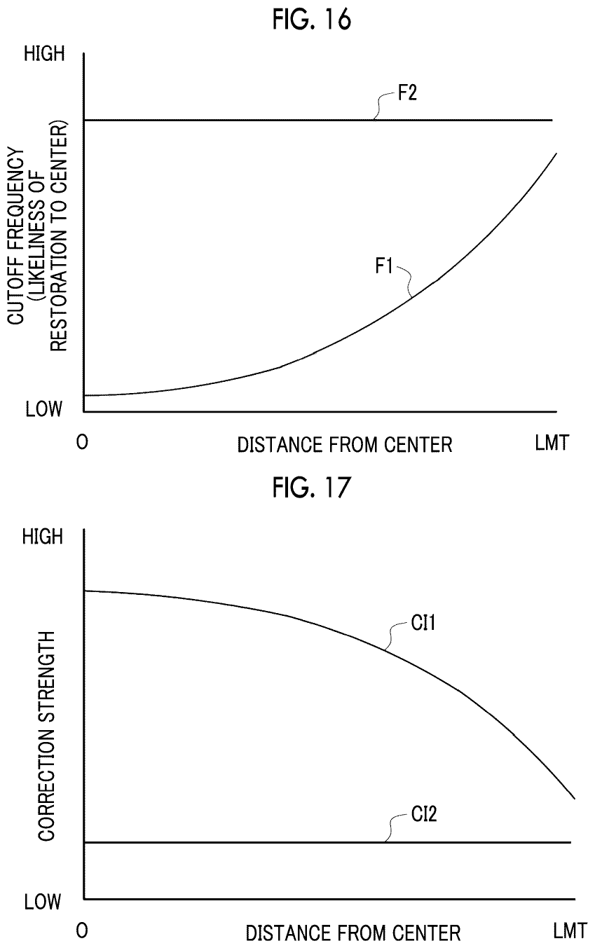

The above embodiment describes an example in which both of the first correction function F1 and the second correction function F2 are functions in which the correction strength is decreased as the position of the recording region RA (an example of the target to be moved) is separated from the center O (an example of the predetermined position). However, as illustrated in FIG. 16, the second correction function F2 may be a function in which the cutoff frequency is constant regardless of the position of the recording region RA. FIG. 17 illustrates a change in correction strength CI2 corresponding to the second correction function F2 illustrated in FIG. 16. Since the second correction function F2 has a constant cutoff frequency, the correction strength CI2 is also constant. The correction strength of the second correction function F2 is lower than that of the first correction function F1. Thus, the restoration time TR can be set to be shorter than that of the first correction function F1 using the second correction function F2.

The second correction function F2 illustrated in FIG. 16 is an example of a function in which an amount of change in the correction strength corresponding to the position of the recording region RA is smaller than that of the first correction function F1. The second correction function F2 may not be a function having a constant cutoff frequency regardless of the position of the recording region RA, as illustrated in FIG. 16, and may be a function in which the amount of change in the correction strength corresponding to the position of the recording region RA is smaller than that of the first correction function F1.

### Second Modification Example: Modification Example 1 of Condition for Applying Second Correction Function

While the above embodiment describes an example in which the condition for applying the second correction function F2 indicates that the panning operation is finished and the predetermined time TD set in advance elapses, other conditions may be used. The second correction function F2 is a function that is applied in a case where the shake caused by the camera shake is not necessary. Examples of a case where the shake caused by the camera shake is not necessary include a case where a transition is made from a state where the user holds the imaging apparatus 10 in a hand to a state where the user fixes the imaging apparatus 10 with a tripod or the like. In a case where the imaging apparatus 10 is fixed to the tripod or the like, a state where the camera shake basically does not occur in the imaging apparatus 10 is set. However, in a case where a transition is made from the handheld state, the position of the recording region RA may not be at the center O because of the shake correction in the handheld state. In such a case, it is desirable to quickly restore the recording region RA to the center O.

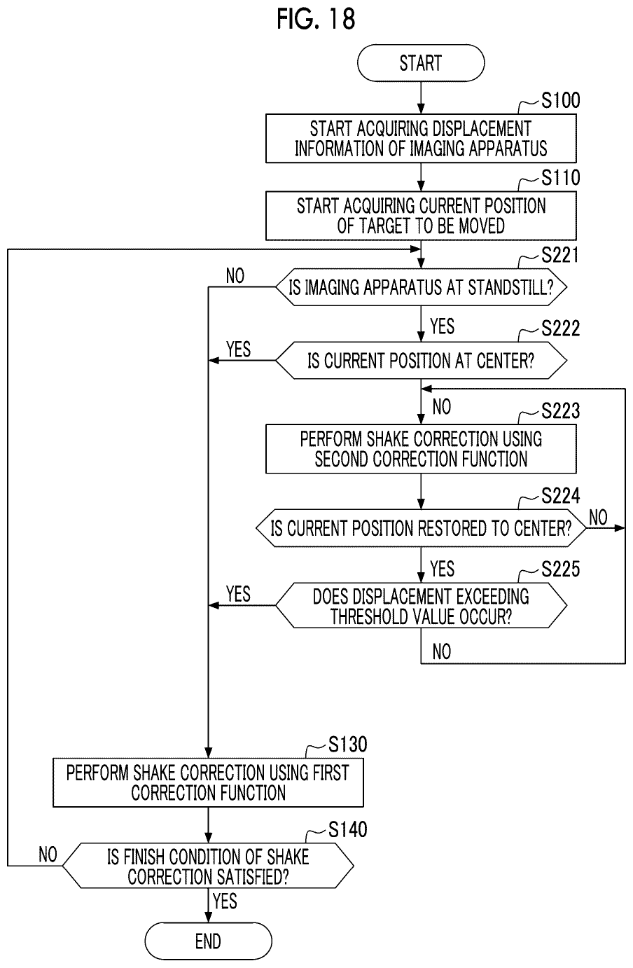

In this case, the processor 40 executes processing as illustrated in FIG. 18. A difference between the flowchart illustrated in FIG. 18 and the flowchart illustrated in FIG. 15 is that steps S121 to S124 related to the determination of the condition for applying the second correction function F2 in FIG. 15 are changed to steps S221 to S225 in FIG. 18. Hereinafter, only the difference will be described.

In step S221, the processor 40 monitors the displacement information and determines whether or not the imaging apparatus 10 is at a standstill. In a case where the imaging apparatus 10 is in the handheld state, the imaging apparatus 10 is in motion. Thus, the angular velocity signal B_{Y} is output for the angular shake in the yaw direction as the displacement information indicating the motion. Meanwhile, in a case where the imaging apparatus 10 is fixed to the tripod or the like, the imaging apparatus 10 is not in motion and is at a standstill, and the corresponding displacement information is output. The displacement information including the angular velocity signal B_{Y} at a standstill is smaller than the displacement information in the handheld state. The processor 40 determines whether or not the imaging apparatus 10 is at a standstill from such a difference in the displacement information.

In step S221, in a case where the processor 40 determines that the imaging apparatus 10 is not at a standstill (NO in step S221), the processor 40 transitions to step S130 and performs the shake correction using the first correction function F1.

Meanwhile, in step S221, in a case where it is determined that the imaging apparatus 10 is at a standstill (YES in step S221), the processor 40 transitions to step S222 and determines whether or not the current position of the recording region RA is at the center O. In a case where it is determined that the current position of the recording region RA is not at the center O (NO in step S222), the processor 40 transitions to step S223 and performs the shake correction using the second correction function F2 instead of the first correction function F1. In step S224, the processor 40 monitors whether or not the position of the recording region RA is restored to the center O, and continues the shake correction using the second correction function F2 until the position of the recording region RA is restored to the center O. Accordingly, the restoration time TR of the recording region RA can be reduced.

In step S224, in a case where it is determined that the recording region RA is restored to the center O (YES in step S224), the processor 40 transitions to step S225. In step S225, the processor 40 monitors whether or not the displacement exceeding a threshold value occurs for the imaging apparatus 10. For example, in a case where the imaging apparatus 10 is detached from the tripod, the imaging apparatus 10 starts moving again from a standstill state, and the displacement exceeding the threshold value set in advance occurs. In step S225, in a case where it is determined that the displacement exceeding the threshold value occurs (YES in step S225), the processor 40 restores the second correction function F2 to the first correction function F1. In step S225, while it is determined that the displacement exceeding the threshold value does not occur (NO in step S225), the processor 40 continues the shake correction using the second correction function F2.

In the second modification example, the predetermined condition as the condition for applying the second correction function F2 includes a condition that the imaging apparatus 10 is determined to be at a standstill. Accordingly, as in a case where the imaging apparatus 10 is fixed by the tripod or the like and is at a standstill, in a case where the shake correction caused by the camera shake is not necessary, the target to be moved can be quickly restored to the predetermined position.

In the second modification example, in a case where the use of the second correction function F2 continues even after the recording region RA (example of the target to be moved) is restored to the center O (example of the predetermined position), and the displacement exceeds the predetermined threshold value, the processor 40 restores the second correction function F2 to the first correction function F1. Accordingly, in a case where the shake correction caused by the camera shake is necessary for the imaging apparatus 10, appropriate shake correction can be performed.

### Third Modification Example: Modification Example 2 of Condition for Applying Second Correction Function

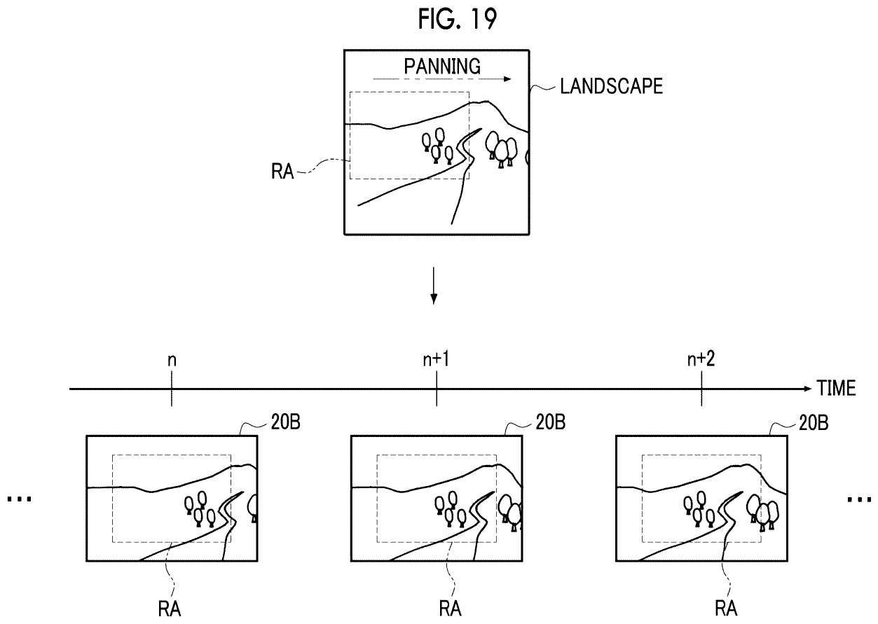

During the period of the panning operation, low correction strength of the shake correction is considered to be acceptable unlike that in the camera shake. For example, as illustrated in FIG. 19, in a case where the camera shake does not occur at all during the panning operation, the position of the recording region RA being always positioned at the center O of the imaging region 20B is considered to be acceptable. In the panning operation, the shake correction caused by the camera shake is likely to be appropriately executed in a case where the recording region RA is positioned at the center O of the imaging region 20B. Furthermore, as the recording region RA is positioned closer to the center O, the restoration time TR of the recording region RA is reduced.

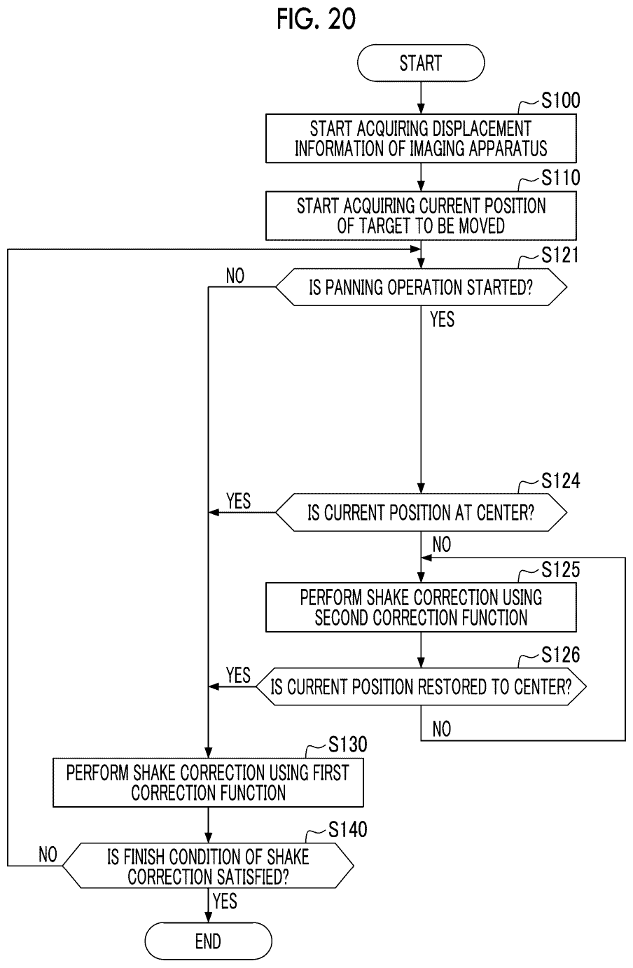

Thus, as in the flowchart illustrated in FIG. 20, in a case where it is determined that the panning operation is started, the processor 40 may switch to the second correction function F2 without waiting for the finish of the panning operation. A difference between the flowchart illustrated in FIG. 20 and the flowchart illustrated in FIG. 15 is that steps S122 and S123 present in FIG. 15 are removed. That is, in the flowchart illustrated in FIG. 20, the condition set in advance for applying the second correction function F2 indicates that the panning operation is being performed. In a case where it is determined that the panning operation is started in step S121, and it is determined that the current position of the recording region RA is not at the center O in step S124, the processor 40 transitions to step S125 and executes the shake correction using the second correction function F2. Accordingly, during the whole period of the panning operation, the correction strength of the shake correction is lower than that in a case where the first correction function F1 is applied. Thus, even in a case where the angular velocity signal B_{Y} is great from the beginning, the correction amount is reduced. Accordingly, the position of the recording region RA is unlikely to be separated from the center O. Then, the restoration time TR to the center O after the panning operation is finished is also reduced.

In the third modification example, the predetermined condition as the condition for applying the second correction function F2 includes a condition that the panning operation is being performed. Accordingly, in a case where correction strength as strong as that of the shake correction caused by the camera shake is not necessary, the target to be moved can be quickly restored to the predetermined position.

While the above embodiment and each modification example illustratively describe the panning operation, the disclosed technology can also be applied in a case where a tilting operation that is a type of camerawork of rotating the imaging direction of the imaging apparatus 10 in a top-to-bottom direction other than the panning operation is performed. In the tilting operation, the angular shake in the pitch direction occurs. Thus, the displacement information is the angular velocity signal B_{X} in the pitch direction.

In the disclosed technology, the panning operation or the tilting operation is an example of a case where correction strength as strong as that of the shake correction caused by the camera shake is not necessary. Such an operation other than the panning operation or the tilting operation includes a type of camerawork such as a translating operation of moving the imaging apparatus 10 in the left-to-right direction or the top-to-bottom direction without rotating. The disclosed technology may be applied to such a translating operation or the like.

That is, the predetermined condition as the condition for applying the second correction function F2 includes a condition that the displacement caused by an operation such as camerawork intended by the user is finished, or the displacement caused during the operation intended by the user continues for a certain amount of time. In the operation such as camerawork intended by the user, correction strength as strong as that of the camera shake correction is generally not necessary. In this case, it is preferable to reduce the restoration time TR of the recording region RA, which is the target to be moved, to the center O by applying the disclosed technology.

While the above embodiment illustratively describes the center O of the imaging region 20B as an example of the “predetermined position” according to the disclosed technology, the predetermined position may not be the center O.

While an example in which the cutoff frequency of the HPF 61B is used as variables of the first correction function F1 and the second correction function F2 is described, the first correction function F1 and the second correction function F2 may be functions using a gain of the multiplier 61C or the integrator 61D as variables. That is, variables are not limited as long as the functions can change the correction strength in accordance with the position of the target to be moved. The first correction function F1 and the second correction function F2 may not be in the form of the LUT 55 and may be in the form of an operation formula.

While the above embodiment illustratively describes electronic anti-vibration as an example of a method of the shake correction, the method of the shake correction method may be mechanical anti-vibration or a combination of the electronic anti-vibration and the mechanical anti-vibration. As is well known, the mechanical anti-vibration includes a sensor shift method of moving the imaging sensor 20 in a direction orthogonal to the optical axis A_{Z} and a lens shift method of shifting the lenses of the imaging lens 12 in the direction orthogonal to the optical axis A_{Z}. Any of these methods may be used as the method of the shake correction. In a case where the method of the shake correction is the sensor shift method, the target to be moved is the imaging sensor 20. In a case where the method of the shake correction is the lens shift method, the target to be moved is the lenses.

The above embodiment and above various modification examples can be combined with each other without causing contradiction.

The above embodiment further discloses the following appendices.

### Appendix 1

An imaging apparatus comprising a processor, in which the processor is configured to acquire displacement information including an orientation and a magnitude of displacement, and positional information of a target to be moved that is moved for shake correction, and in a case where the displacement information satisfies a predetermined condition, and a position of the target to be moved is not at a predetermined position, determine a correction amount of the target to be moved using a second correction function of which a restoration time of the target to be moved to the predetermined position is shorter than a restoration time of a first correction function, instead of the first correction function.

### Appendix 2

The imaging apparatus according to Appendix 1, in which the predetermined condition includes a condition that a panning operation or a tilting operation is finished and a time set in advance elapses.

### Appendix 3

The imaging apparatus according to Appendix 2, in which the processor is configured to, during the panning operation or the tilting operation, determine the correction amount using the first correction function.

### Appendix 4

The imaging apparatus according to Appendix 2 or 3, in which the processor is configured to, in a case where the target to be moved is restored to the predetermined position, restore the second correction function to the first correction function.

### Appendix 5

The imaging apparatus according to Appendix 1, in which the predetermined condition includes a condition that a panning operation or a tilting operation is being performed.

### Appendix 6

The imaging apparatus according to Appendix 1, in which the predetermined condition includes a condition that the displacement caused by an operation intended by a user is finished, or the displacement caused during the operation intended by the user continues for a certain amount of time.

### Appendix 7

The imaging apparatus according to Appendix 1, in which the predetermined condition includes a condition that the imaging apparatus is determined to be at a standstill.

### Appendix 8

The imaging apparatus according to Appendix 7, in which the processor is configured to, in a case where use of the second correction function continues even after the target to be moved is restored to the predetermined position, and the displacement exceeds a predetermined threshold value, restore the second correction function to the first correction function.

### Appendix 9

The imaging apparatus according to any one of Appendices 1 to 8, in which both of the first correction function and the second correction function are functions in which correction strength is decreased as the position of the target to be moved is separated from the predetermined position.

### Appendix 10

The imaging apparatus according to any one of Appendices 1 to 8, in which the first correction function is a function in which correction strength is decreased as the position of the target to be moved is separated from the predetermined position, and the second correction function is a function in which an amount of change in the correction strength corresponding to the position of the target to be moved is smaller than an amount of change in the correction strength of the first correction function.

### Appendix 11

The imaging apparatus according to any one of Appendices 1 to 10, in which the target to be moved is an imaging sensor in a case where a method of the shake correction is a sensor shift method, a lens in a case where the method of the shake correction is a lens shift method, or an image cutout position in a case where the method of the shake correction is an electronic correction method.

### Appendix 12

An operation method of an imaging apparatus including a processor, the method comprising, via the processor, acquiring displacement information including an orientation and a magnitude of displacement, and positional information of a target to be moved that is moved for camera shake correction, and determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.

### Appendix 13

An operation program of an imaging apparatus including a processor, the program causing the processor to execute a process comprising acquiring displacement information including an orientation and a magnitude of displacement, and positional information of a target to be moved that is moved for camera shake correction, and determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.

In the above embodiment, each type of processing is executed by any computer. Any computer may execute those types of processing via a processor as hardware, a program as software, or a combination thereof. In this case, the processor is configured to execute various types of processing in the present embodiment in cooperation with the program, and may function as each unit or each means in the present embodiment. A processing order of the processing performed by the processor is not limited to the described order and may be appropriately changed.

Any computer may be a general-purpose computer, a computer for a specific application, a workstation, or other systems capable of executing each type of processing. The processor may be composed of one or a plurality of pieces of hardware, and a type of hardware is not limited. For example, the processor may be composed of hardware such as a central processing unit (CPU), a micro processing unit (MPU), a programmable logic device such as a field programmable gate array (FPGA), a dedicated circuit for executing specific processing, such as an application specific integrated circuit (ASIC), a graphic processing unit (GPU), or a neural processing unit (NPU). Types of hardware may be a combination of different types of hardware. In a case where a plurality of pieces of hardware are configured to execute one or a plurality of types of processing of the processor, the plurality of pieces of hardware may be present in apparatuses physically separated from each other or may be present in the same apparatus. In any embodiment, the order of each type of processing performed by the processor is not limited to the above order and may be appropriately changed. The hardware is composed of an electric circuit (circuitry) in which circuit elements such as semiconductor elements are combined.

The program may be software such as firmware or a microcode. For example, the program may be a program module group, and each function thereof may be implemented by the processor configured to execute each function. The program may be a program code or a plurality of code segments stored in one or a plurality of non-transitory computer-readable media (for example, storage media or other storages). The program may be divided and stored in a plurality of non-transitory computer-readable media present in apparatuses physically separated from each other. The program code or the code segments may represent any combination of a procedure, a function, a subprogram, a routine, a subroutine, a module, a software package, a class, an instruction, a data structure, and a program statement. The program code or the code segments may be connected to other code segments or hardware circuits by transmitting and receiving information, data, an argument, a parameter, or content of a memory.

In the disclosed technology, the above various embodiments and/or various modification examples can be appropriately combined with each other. The disclosed technology is not limited to the above embodiment and may adopt various configurations without departing from its gist. The disclosed technology also applies to, in addition to the program, a storage medium storing the program in a non-transitory manner. The storage medium is, for example, a non-transitory computer-readable storage medium such as a universal serial bus (USB) memory, a flexible disk, or a compact disc read only memory (CD-ROM). The program may be provided online through a network such as the Internet. The disclosed technology also applies to a program product in addition to the program. The program product includes products of every aspect for providing the program. Like the program, the program product may be provided by being stored in a non-transitory computer-readable storage medium or may be provided online.

The described contents and the illustrated contents shown above are detailed descriptions of parts according to the disclosed technology and are merely an example of the disclosed technology. For example, description related to the above configurations, functions, actions, and effects is description related to examples of configurations, functions, actions, and effects of the parts according to the disclosed technology. Thus, unnecessary parts may be removed, new elements may be added, or parts may be replaced in the described contents and the illustrated contents shown above without departing from the gist of the disclosed technology. Description related to common technical knowledge or the like that does not require particular description in terms of embodying the disclosed technology is omitted in the described contents and the illustrated contents shown above, in order to avoid complication and facilitate understanding of the parts according to the disclosed technology.

In the present specification, “A and/or B” is synonymous with “at least one of A or B”. That is, “A and/or B” may mean only A, only B, or a combination of A and B. In the present specification, the same approach as “A and/or B” applies to an expression of three or more matters connected with “and/or”.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. An imaging apparatus comprising:
a processor,
wherein the processor is configured to:
acquire displacement information including an orientation and a magnitude of displacement, and positional information of a target to be moved that is moved for shake correction; and
in a case where the displacement information satisfies a predetermined condition, and a position of the target to be moved is not at a predetermined position, determine a correction amount of the target to be moved using a second correction function of which a restoration time of the target to be moved to the predetermined position is shorter than a restoration time of a first correction function, instead of the first correction function.

2. The imaging apparatus according to claim 1,
wherein the predetermined condition includes a condition that a panning operation or a tilting operation is finished and a time set in advance elapses.

3. The imaging apparatus according to claim 2,
wherein the processor is configured to, during the panning operation or the tilting operation, determine the correction amount using the first correction function.

4. The imaging apparatus according to claim 2,
wherein the processor is configured to, in a case where the target to be moved is restored to the predetermined position, restore the second correction function to the first correction function.

5. The imaging apparatus according to claim 1,
wherein the predetermined condition includes a condition that a panning operation or a tilting operation is being performed.

6. The imaging apparatus according to claim 1,
wherein the predetermined condition includes a condition that the displacement caused by an operation intended by a user is finished, or the displacement caused during the operation intended by the user continues for a certain amount of time.

7. The imaging apparatus according to claim 1,
wherein the predetermined condition includes a condition that the imaging apparatus is determined to be at a standstill.

8. The imaging apparatus according to claim 7,
wherein the processor is configured to, in a case where use of the second correction function continues even after the target to be moved is restored to the predetermined position, and the displacement exceeds a predetermined threshold value, restore the second correction function to the first correction function.

9. The imaging apparatus according to claim 1,
wherein both of the first correction function and the second correction function are functions in which correction strength is decreased as the position of the target to be moved is separated from the predetermined position.

10. The imaging apparatus according to claim 1,
wherein the first correction function is a function in which correction strength is decreased as the position of the target to be moved is separated from the predetermined position, and
the second correction function is a function in which an amount of change in the correction strength corresponding to the position of the target to be moved is smaller than an amount of change in the correction strength of the first correction function.

11. The imaging apparatus according to claim 1,
wherein the target to be moved is
an imaging sensor in a case where a method of the shake correction is a sensor shift method,
a lens in a case where the method of the shake correction is a lens shift method, or
an image cutout position in a case where the method of the shake correction is an electronic correction method.

12. An operation method of an imaging apparatus including a processor, the method comprising:
via the processor,
acquiring displacement information including an orientation and a magnitude of displacement, and positional information of a target to be moved that is moved for camera shake correction; and
determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.

13. A non-transitory computer-readable storage medium storing an operation program of an imaging apparatus including a processor, the program causing the processor to execute a process comprising:
acquiring displacement information including an orientation and a magnitude of displacement, and positional information of a target to be moved that is moved for camera shake correction; and
determining, in a case where the displacement information satisfies a predetermined condition, and a position of the target to be moved is not at a predetermined position, a correction amount of the target to be moved using a second correction function of which a restoration time of the target to be moved to the predetermined position is shorter than a restoration time of a first correction function, instead of the first correction function.
